(19) United States
(12) Patent Application Publication
(10) Pub. No.: US 2004/0139708 A1
(43) Pub. Date: Jul. 22, 2004

(54) Vehicle air filter adapter and method

(76) Inventor: John C. Giacinto, Charleston, SC (US)

Correspondence Address: KATHLEEN M HARLESTON, THE HARLESTON LAW FIRM, 909 TALL PINE ROAD, MT PLEASANT, SC, 29464

(21) Appl. No.: 10/347,809

(22) Filed: Jan. 21, 2003

(51) Int. Cl. B01D 46/00

(52) U.S. Cl. 55/385.3; 95/273; 96/108; 55/490; 55/502

(57) ABSTRACT

An air filter adapter for motorcycles and other motorized vehicles includes:

(a) a substantially cylindrical top portion including a neck ending in a generally circular upper ring opening;

(b) a bottom portion including a substantially cylindrical lower band extending from the neck, the lower band ending in a generally circular lower ring opening; wherein the upper ring opening has a substantially smaller diameter than the diameter of the lower ring opening; and the neck and lower band are generally vertically oriented, the neck being removably attachable to an opening of a housing of the air filter, the lower band being removably attachable to an open end of a carburetor duct of a carburetor. Also included is a method for increasing efficiency of a motorcycle engine using the adapter.

### BACKGROUND OF THE INVENTION

1. Technical Field

The present invention relates to an adapter for use in a motorized vehicle with a combustion-type engine, particularly a motorcycle, for connecting an air filter housing and a carburetor of the vehicle; and a method for increasing efficiency of a motorcycle engine employing the adapter between the air filter housing and a duct of the carburetor.

2. Background Information

Many motorcycle enthusiasts are fastidious about their motorcycles. One way to keep a motorcycle engine clean and therefore improve engine performance would be to improve the filtration of air prior to its entry into the motorcycle carburetor.

In general, many conventional motorcycles come with a large, empty, stock air box that fits within a cavity in the motorcycle's gas tank. Two carburetor ducts leading to the carburetor are fixed to the air box. A single small air filter below and to one side of the air box is connected by a short hose to a small opening in the air box. The air box contains the filtered air. From there, the filtered air flows through the carburetor ducts into the carburetor.

In the present invention, the stock air box has been removed, leaving room for two air filters. The air filters rest on top of the carburetor ducts. Each air filter is connected to one of the carburetor ducts by the adapter of the present invention. Air passes through the filters, then the adapters, then the carburetor ducts and the carburetor. In comparison to the single air filter in the conventional set-up, the two air filters of the present invention at least double the amount of filter available for filtering particles out of the contaminated incoming air stream. The amount of filter area available varies somewhat according to the type of air filter and the make of the motorcycle. The cleaner air stream of the present invention has fewer particles in it to foul the carburetor. It therefore helps the engine to perform more efficiently, and has the beneficial byproduct of adding horse power and torque.

### BRIEF SUMMARY OF THE INVENTION

The present invention is an air filter adapter for removably attaching a disposable air filter to a carburetor, including:

(a) a substantially cylindrical top portion comprising a neck ending in a generally circular upper ring opening;

(b) a bottom portion comprising a substantially cylindrical lower band extending from the neck, the lower band ending in a generally circular lower ring opening;

wherein the upper ring opening has a substantially smaller diameter than the diameter of the lower ring opening; and the neck and lower band are generally vertically oriented, the neck being removably attachable to an opening of a housing of the air filter, the lower band being removably attachable to an open end of a carburetor duct, an opposite end of the carburetor duct being connected to the carburetor.

Also included herein is a method for increasing efficiency of a motorcycle engine, including the steps of:

a) removing a stock air box, stock air filter, and stock hose between the stock air filter and the stock air box of the motorcycle;

b) inserting a portion of at least one adapter into a carburetor duct of the motorcycle, the at least one adapter comprising: (1) a substantially cylindrical top portion comprising a neck ending in a generally circular upper ring opening; and (2) a bottom portion integral with the top portion, the bottom portion comprising a substantially cylindrical band extending from the neck, the band ending in a generally circular lower ring opening, the upper ring opening having a substantially smaller diameter than the diameter of the lower ring opening;

c) inserting an end of at least one removable air filter housing into the top portion of the at least one adapter; and

d) removably attaching the at least one adapter in place;

whereby the air filter housing is removably connected to a carburetor of the motorcycle by at least one of the carburetor ducts through the adapter.

### BRIEF DESCRIPTION OF THE SEVERAL VIEWS OF THE DRAWINGS

A more complete understanding of the invention and its advantages will be apparent from the following detailed description taken in conjunction with the accompanying drawings, wherein examples of the invention are shown, and wherein:

FIG. 1 is a perspective view of an air filter adapter according to the present invention;

FIG. 2 is an elevational view of a motorcycle air filter adapter according to the present invention, shown in an air filter housing and a carburetor duct;

FIG. 2b is an elevational view of an alternate embodiment of an air filter adapter according to the present invention, shown on an air filter housing and a carburetor duct;

FIG. 3 is a bottom plan view of the air filter adapter according to FIG. 1;

FIG. 4 is a top plan view of the air filter adapter according to FIG. 1;

FIG. 5 is a cross-sectional view of an upper lip of the air filter adapter according to FIG. 2;

FIG. 6 is a cross-sectional view of a lower lip of the air filter adapter according to FIG. 2;

FIG. 7 is an elevational view of two air filter adapters according to the present invention, shown on a motorcycle;

FIG. 8 is a perspective view of an alternate embodiment of an air filter adapter according to the present invention;

FIG. 9 is a top plan view of an alternate embodiment of an air filter adapter according to the present invention;

FIG. 10 is an elevational view of the air filter adapter according to FIG. 9;

FIG. 11 is a perspective view of an alternate embodiment of an air filter adapter according to the present invention;

FIG. 12 is a perspective view of the air filter adapter according to FIG. 11, shown attached to an air filter housing and a carburetor duct;

FIG. 13 is a perspective view of an alternate embodiment of an air filter adapter according to the present invention; and

FIG. 14 is a bottom plan view of the air filter adapter according to FIG. 13.

### DETAILED DESCRIPTION OF THE INVENTION

In the following description, like reference characters designate like or corresponding parts throughout the several views. Also, in the following description, it is to be understood that such terms as “front,” “back,” “within,” and the like are words of convenience and are not to be construed as limiting terms. Referring in more detail to the drawings, the invention will now be described.

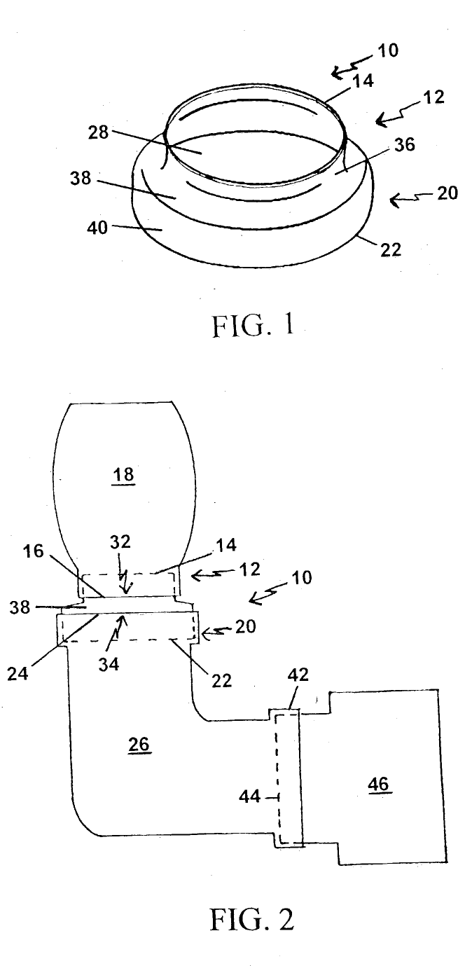

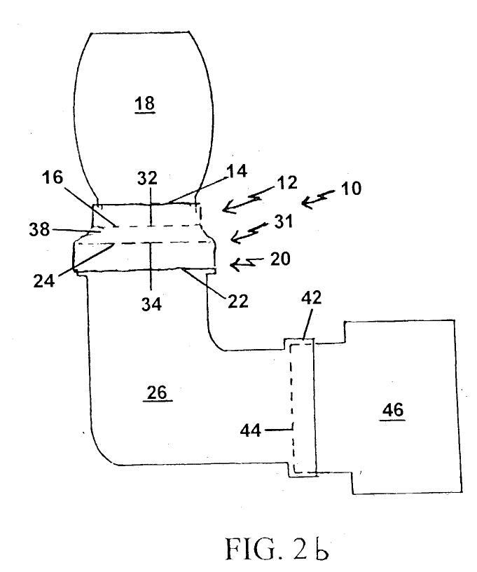

Turning first to FIGS. 1 and 2, an air filter adapter, generally referred to as 10, for a motorcycle (not shown) or other motorized vehicle with a combustion-type engine, such as a car, truck, or boat. The adapter 10, which can also be called a connector, includes a generally cylindrical top portion 12, the upper ring end 14 of which is closely insertable into an outlet opening 16 of an air filter housing 18, continuing into a larger diameter, generally cylindrical bottom adapter portion 20. The lower ring end 22 of the bottom portion 20 is closely insertable into an air inlet opening 24 of a generally L-shaped carburetor duct 26.

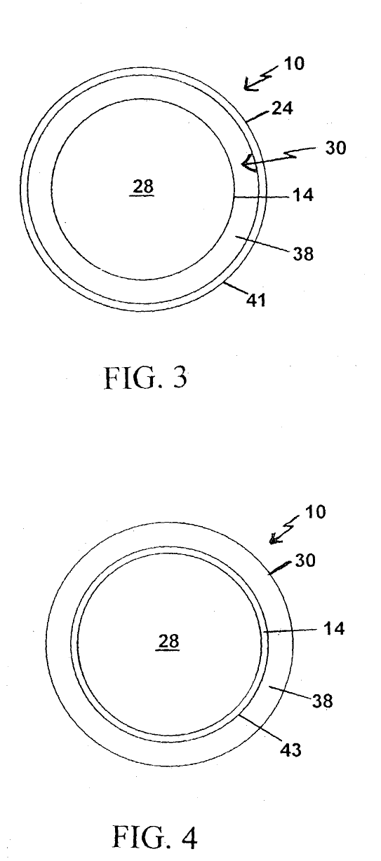

As shown in FIGS. 1, 3 (bottom view) and 4 (top view), the top adapter portion 12 includes a generally circular inlet opening 28, and the bottom adapter portion 20 includes a generally circular outlet opening 30. The adapter inlet opening 28 has a smaller diameter than the outlet opening 30.

Referring to FIG. 2b, in an alternate, less preferred embodiment 31 of the adapter, the upper ring end 14 is closely and removably attachable over the outside of the lower end 32 of the air filter housing 18, and the lower ring end 22 of the adapter is closely and removably attachable over the outside of the upper end 34 of the carburetor duct. In this embodiment 31, the diameters of the upper ring end 14 and the lower ring end 22 are greater than the corresponding diameters of the more preferred adapter embodiment 10.

Continuing with FIGS. 1, 3 and 4, the top portion 12 further includes the neck 36, which continues down into the larger diameter, central yoke 38 of the bottom portion 20, which in turn extends into the lower band 40. The bottom portion 20 of the adapter 10 includes the yoke 38 and the lower band 40. The neck 36 and lower band 40 are substantially vertically oriented, as is the air filter housing, while the yoke 38 in this preferred embodiment is substantially horizontally oriented. In this preferred embodiment, the neck 36 and lower band 40 are generally straight and cylindrical, with a substantially consistent diameter, so that they fit into the cylindrical openings of the air filter housing 18 and carburetor duct 26, while the yoke 38 is slightly curved.

As shown in FIG. 2, the opposite, open end 42 of the generally cylindrical, L-shaped carburetor duct 26 is inserted into an opening 44 of a carburetor 46. The adapter yoke 38 is visible between the air filter housing 18 and the carburetor duct 26 in FIG. 2.

As can be seen in the bottom and top plan views of FIGS. 3 and 4, respectively, the lower band 40 of the adapter 10 has a larger inside and outside diameter than the adapter neck 36. FIG. 3 illustrates a lower lip 41 and the substantially even thickness and verticality of the wall of the band. FIG. 4 shows an upper lip 43 of the adapter 10, and the substantially even thickness and verticality of the neck 36. FIG. 3 shows the inside of the generally horizontal yoke 38, and FIG. 4 shows the outside of the yoke. Since the upper ring 14 has a smaller diameter than the lower ring 22, the inlet opening 28 has a smaller diameter than the outlet opening 30.

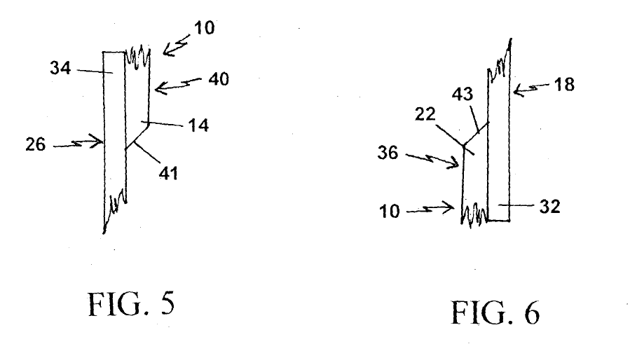

Referring to FIGS. 5 and 6, in a preferred embodiment, an upper lip 43 on the upper ring end 14, and/or a lower lip 41 on the lower ring end 22, of the air filter adapter are beveled rather than being flat. The upper and/or lower lips 41, 43 preferably angle outward toward the wall of the air filter housing 18 or the carburetor duct 26, as shown in FIGS. 5 and 6. In comparison to a flat lip, the angled lip (e.g., 45 degree angle) allows the air stream to pass through the central air passage of the adapter with less interference. It is believed- to help in the Venturi effect of the air flow within the filter/adapter/duct unit 48. In addition to facilitating the rapid passage of air through the air filter housing opening and the carburetor duct opening, which are now slightly occluded by the adapter, dirt and dust particles are less likely to deposit and accumulate on the angled lips (versus a flat lip).

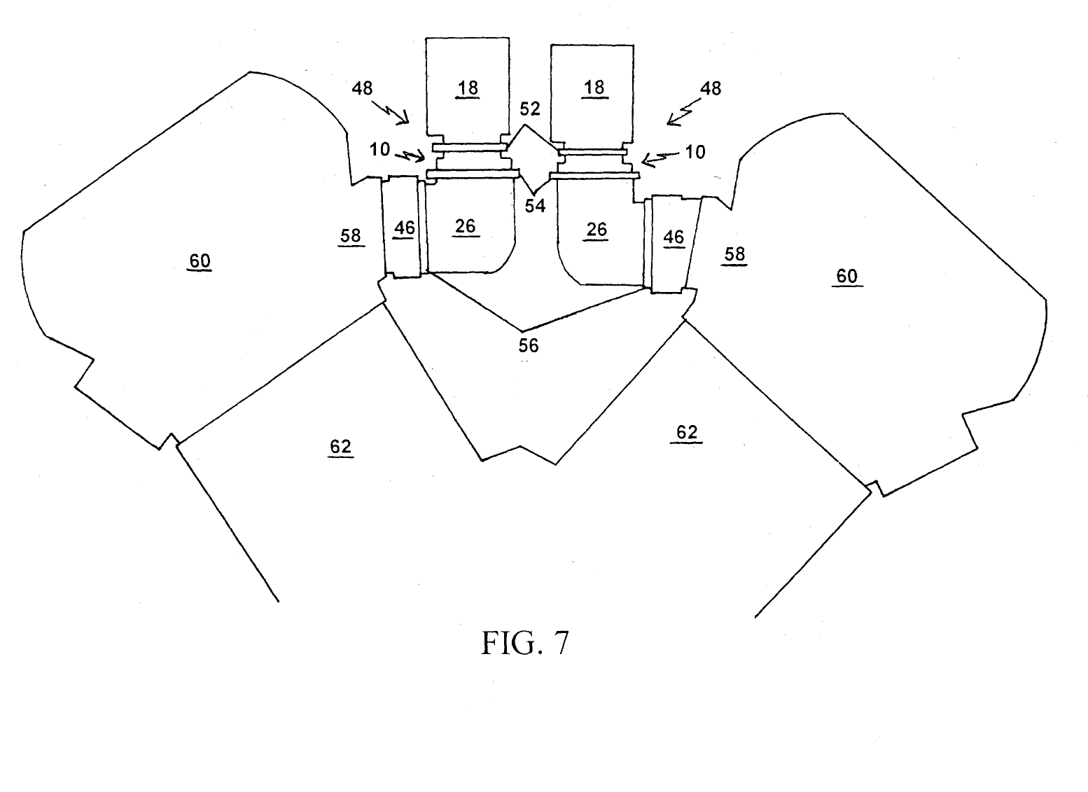

Turning to FIG. 7, a motorcycle preferably includes a set of mirror-image air filter/adapter/carburetor duct/carburetor units 48 shown in FIG. 2. The two air filter housings 18 hooked up to their corresponding adapters 10 are fitted onto the carburetor ducts, ordinarily within a space in the gas tank of the motorcycle. The space is available as a result of the removal of a stock air box/air filter set-up that comes with the motorcycle.

As shown in FIG. 7, the lower end 32 of the air filter housing 18 is clamped onto the upper ring end 14 of the adapter 10 by any suitable means, preferably by a removable first ring clamp 52. The filter outlet opening 16 is surrounded by a rubber flange (not shown), which improves the seal between the adapter 10 and the air filter housing 18. The upper end 34 of the carburetor duct 26 is clamped over the outlet opening 30 of the adapter 10 by any suitable means, preferably via a removable second ring clamp 54. The first ring clamp 52 is affixed around the outside of the lower end 32 of the air filter housing 18. When it is tightened, it clamps the air filter housing around the neck of the adapter. The second ring clamp 54 is affixed around the outside of the upper end 34 of the carburetor duct 26. When the ring clamp is tightened, the carburetor duct material is clamped around the lower band of the adapter. The opposite, open end 42 of the carburetor duct is clamped to the carburetor opening 44 by any suitable means, preferably by a removable third ring clamp 56. Wire clamps may be employed instead of ring clamps 52, 54, 56, if desired.

The gas tank, which is not shown in FIG. 7 for clarity, fits over the top of the two filter/adapter/carburetor duct units 48. As illustrated in FIG. 7, the carburetors 46 on either side are connected via intake manifolds 58 to the cylinder heads 60. The cylinder heads 60 are on top of cylinders 62 of the motorcycle engine. This view would vary with the different motorcycle models and brands.

The present invention further includes a kit for the convenience of motorcycle owners, which includes at least one after market air filter, and preferably two, in a filter housing 18; an adapter 10; ring clamps 52, 54; spare parts, such as screws, washers, and/or drill bits; tools, such as a small screwdriver, Allen wrenches, and/or drill; and/or conventional carburetor jets (which could be of different sizes). This saves the owner time in going to the store and gathering or finding these items.

The adapter 10 is preferably unitary and made of a cost-effective, chip-resistant, durable, plastic-type material. Polypropylene and ABS plastic are more preferred materials. A polypropylene/polyethylene copolymer is most preferred. The copolymer has been found to be flexible enough to clamp to the carburetor duct 26 or air filter housing 18, yet it is sturdy enough to withstand stress under the ring clamps 52, 54, as well as ordinary road stress. The inside and outside walls of the adapter are smooth so that dirt and dust particles are less likely to adhere to the adapter. The most preferred, polypropylene/polyethylene copolymer may be low, medium, or high density. The high density copolymer is most preferred because adapters 10 made from it have been found to be durable in a motorcycle engine.

The adapters herein may be made by any suitable process, including injection molding. The adapters are more preferably made by a vacuforming process using a plastic mold.

Before starting the motorcycle, the adapter 10 is installed between the air filter housing 18 and the carburetor duct 26, as shown and described herein. Once the motorcycle is started, the air passes through the annular filter elements (not shown) mounted in the air filter housing 18. The air filters are preferably sponge foam rubber air filters with a cellulose/paper filter element. As the air passes by, particles entrained in the air stream are filtered out by the annular filter elements. Dirt and dust particles of a size determined by the filter type and the size of the pores of the filter are caught within the filters. The air stream then proceeds down the carburetor duct and through the carburetor.

When the air filter is soiled, or at a specified mileage point, it is removed and replaced. Dismantling is easily accomplished by unclamping the first and second ring clamps, removing the disposable air filter, and the adapter. The soiled air filters are then disposed of properly and replaced. The adapter may be used again and again. The adapter fits closely into the opening of the air filter housing, so as to prevent the air from escaping at the juncture between the adapter and the air filter housing.

Included in the present invention is a method for increasing the efficiency of a motorcycle engine, including the steps of:

a) removing a stock air box, stock air filter, and stock hose between the stock air filter and the stock air box of the motorcycle;

b) inserting the adapter 10 into a carburetor duct 26 of the motorcycle;

c) inserting an end of at least one removable air filter housing 18 into the top portion 12 of the adapter 10; and

d) removably attaching the adapter 10 in place, preferably by means of a ring clamp 52, 54, 56. Each of the air filters is removably connected to a carburetor 46 of the motorcycle by a carburetor duct 26 through an adapter 10, so that filtered air is channeled through the carburetor. The adapter 10 includes: (1) a substantially cylindrical top portion 12 including a neck 36 ending in a generally circular upper ring opening 28; and (2) a bottom portion 20 integral with the top portion 12. The bottom adapter portion 20 includes a substantially cylindrical band 40 extending down from the neck 36. The lower band 40 ends in a generally circular lower ring opening. The upper ring 14 has a substantially smaller diameter than the diameter of the lower ring 22. There are preferably two of the air filter housings 18. An end of each of the air filter housings is removably connected to the top portion 12 of an adapter. The bottom portion 20 of the adapter 10 is preferably removably connected to an upper end 34 of the motorcycle carburetor duct 26. The motorcycle preferably has two of the adapters 10, and two of the carburetor ducts 26.

The present adapter 10 serves to connect the carburetor duct, with its larger diameter opening, to the smaller opening of the air filter housing 18. The adapter 10 allows a larger air filter to be used, and increases the number of square inches of space available for air filtration. Since fewer abrasive particles are clogging or damaging the carburetor, the engine is more efficient. The adapter 10 increases air filter area, and increases horsepower, and is believed to thus improve gas mileage.

The motorcycle in particular has a compact space for working in. There is not a lot of room for equipment. The present adapter is sized to perform well, and not take up space. It is advantageous in such a small space to have a separate part (the adapter) because of the space problem.

The adapter allows a layman to convert a standard motorcycle with one compact, inexpensive, easy to install part: the adapter of the present invention. The availability of the adapter 10 to consumers translates to cost savings for air filter manufacturers, since it is not necessary for them to retool their air filters to fit on each motorcycle model.

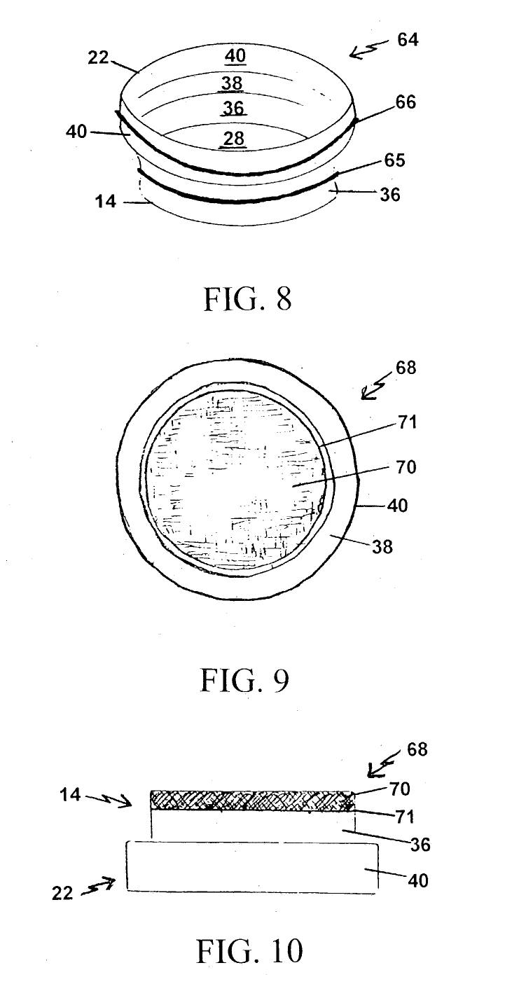

Turning to a third alternate adapter embodiment 64, as depicted in FIG. 8, a substantially malleable, circular upper annulus 65 encircling the outside of the adapter neck 36 helps the adapter 64 closely fit into the opening of the air filter housing 18. Also, a substantially malleable, circular lower annulus 66 around the outside of the lower band 40 helps the adapter closely fit into the carburetor duct opening. The thin annulus 65, 66 is preferably made of a natural or synthetic rubber-type material. Where the adapter 64 is made of a plastic-type material, a slightly rounded annulus 65, 66 can be inserted into a thin groove (beneath the annulus, not shown) formed in the inner wall of the neck and/or lower band of the adapter, and adhered within the groove, so that it projects slightly above the adapter surface for a tight fit into the air filter housing or carburetor duct opening. The annulus 65, 66 forms a substantially air tight seal. Unfiltered air is less likely to escape through a gap between the air filter housing 18 and the adapter 64, or the adapter 64 and the carburetor duct 26, when the annulus 65, 66 is present. Particles from unfiltered air could eventually cause damage to the engine.

Turning to a fourth alternate embodiment 68 of the adapter, which is depicted in FIGS. 9 and 10, a fine, removable net 70 is positioned across the inlet opening 28 of the adapter to further screen out any particles entrained in the air stream that were not caught in the air filter elements. The adapter net 70 may optionally be imbued with a chemical for absorbing a potentially harmful gas in the air stream, or small charcoal particles may be suspended in its netting for absorbing absorbable, harmful particles. The fine but durable net 70 is held tautly across the inlet opening 28 of the adapter by the close fit into the opening of the air filter housing 18. The circular net 70 shown in FIGS. 9 and 10 is bounded and held taut by a rubber-type ring 71 that fits closely around the upper ring end 14 of the adapter 68.

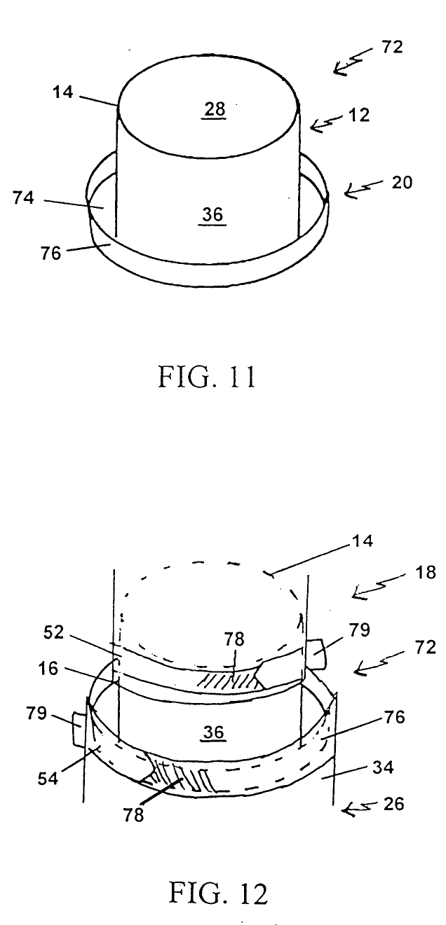

FIGS. 11 and 12 illustrate a fifth alternate embodiment 72 of the adapter, which resembles a top hat with no top. As in the most preferred embodiment, a cylindrical top portion 12 includes an upper ring end 14 with an inlet opening 28. As shown in FIG. 12, the upper ring end 14 is inserted into the outlet opening 16 of the air filter housing 18 and a first ring clamp 52 is fastened around the outside of the end of the air filter housing to hold the adapter 72 in place. The inside of this adapter does not bell out; the upper ring end 14 at the top of the neck has substantially the same diameter as the bottom of the neck. This embodiment 72 provides a straight, uninterrupted path for the air stream. In some applications, particularly where the carburetor ducts are an unusual length or diameter, or where incoming air turbulence is a problem, this version of the adapter would be preferred.

As depicted in FIG. 11, a substantially planar, ring-shaped yoke 74 extends out from the lower end of the generally vertical neck 36 at about a 90 degree angle. An inverted band 76 extends upward from the generally horizontal yoke 74 in a generally vertical direction. As shown in FIG. 12, the inverted band 76 fits into the opening of the carburetor duct 26, which ordinarily has a greater diameter than the outlet opening of the air filter housing. A second ring clamp 54 is fastened around the outside of the end of the carburetor duct 26 to hold the adapter 72 in place. The ring clamps 52, 54 include sets of slots 78 for tightening or loosening them using the screws 79 that are part of the clamps.

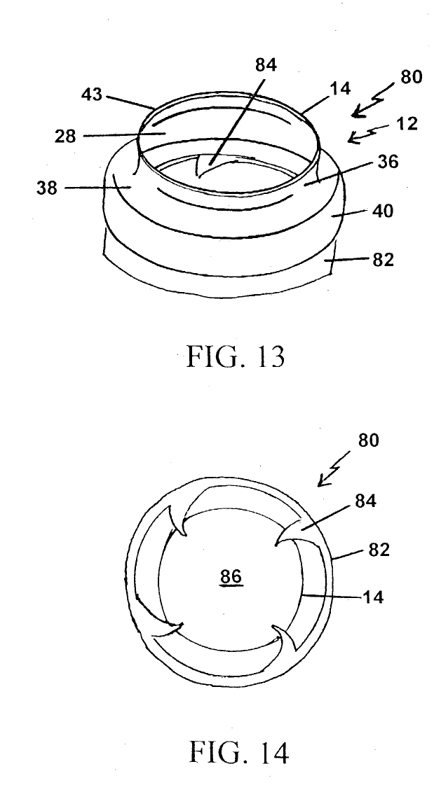

FIGS. 13 and 14 show a sixth alternate embodiment 80 of the adapter. This embodiment 80 resembles the first embodiment 10 described hereinabove. It includes a wind ring 82, which is attachable to the lower ring end 22 of the bottom portion 20. The wind ring 82 preferably has the same outside diameter as the lower ring end, and may be attached to the lower ring end with a suitable strong adhesive. The wind ring 82 is preferably made of a metallic material, more preferably a stamped brass-containing material. The wind ring 82 includes a number, most preferably four to six, matching fins 84, which project into the central hollow 86 that extends through the adapter and into the carburetor duct. A preferred embodiment has four substantially identical fins 84, all extending in the same direction at about a ninety degree angle from the lower band and the wind ring, as shown. Without meaning to be bound by theory, it is believed that the fins 84 cause the air stream rushing through the central hollow 86 when the motorcycle is in use to swirl. This swirling motion is believed to concentrate the air flow, giving a more efficient mixture of air and fuel as it flows through the carburetor.

Alternatively, a swirl cut into the inside wall of the neck and/or lower band of the adapter is believed to facilitate air flow through the central hollow of the adapter, which is a relatively small and confined space in comparison to the carburetor duct, for example. Also, the outside of the lower band of the adapter may be roughed-up for a better grip by the user during installation. The adapter may alternatively include a small handle or an extended outside edge for the user to grasp during installation.

From the foregoing it can be realized that the described device of the present invention may be easily and conveniently utilized as an adapter for a vehicle air filter. It is to be understood that any dimensions given herein are illustrative, and are not meant to be limiting.

While preferred embodiments of the invention have been described using specific terms, this description is for illustrative purposes only. It will be apparent to those of ordinary skill in the art that various modifications, substitutions, omissions, and changes may be made without departing from the spirit or scope of the invention, and that such are intended to be within the scope of the present invention as defined by the following claims. It is intended that the doctrine of equivalents be relied upon to determine the fair scope of these claims in connection with any other person's product which fall outside the literal wording of these claims, but which in reality do not materially depart from this invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

### LIST OF REFERENCE NUMBERS USED IN THE DRAWINGS

10 adapter

12 top portion

14 upper ring end

16 outlet opening of air filter

18 air filter housing

20 bottom portion

22 lower ring end

24 inlet opening of duct

26 carburetor duct

28 inlet opening of adapter

30 outlet opening of adapter

31 second adapter embodiment

32 lower end of air filter

34 upper end of duct

36 neck of adapter

38 yoke of adapter

40 lower band of adapter

41 lower lip of adapter

42 end of carburetor duct

43 upper lip of adapter

44 opening of carburetor

46 carburetor

48 filter/adapter/duct/carburetor unit

50 motorcycle gas tank

52 first ring clamp

54 second ring clamp

56 third ring clamp

58 intake manifold

60 cylinder head

62 cylinder

64 third adapter embodiment

65 upper annulus

66 lower annulus

68 fourth alternate embodiment

70 net

71 net ring

72 fifth alternate embodiment

74 yoke of fifth embodiment

76 band of fifth embodiment

78 slots in ring clamp

79 screw of ring clamp

80 sixth alternate embodiment

82 wind ring

84 ring fins

86 central hollow

What is claimed is:

1. An air filter adapter for removably attaching a disposable air filter to a carburetor, the adapter comprising:
(a) a substantially cylindrical top portion comprising a neck ending in a generally circular upper ring opening;
(b) a bottom portion integral with the top portion, the bottom portion comprising a substantially cylindrical lower band extending from the neck, the lower band ending in a generally circular lower ring opening;
wherein the upper ring opening has a substantially smaller diameter than the diameter of the lower ring opening; and the neck and lower band are generally vertically oriented, the neck being removably attachable to an opening of a housing of the air filter, the lower band being removably attachable to an open end of a carburetor duct, an opposite end of the carburetor duct being connected to the carburetor.

2. An adapter according to claim 1, further comprising removable attachment means for removably connecting a lower end of the air filter housing to the adapter neck, and for removably connecting an upper end of the carburetor duct to the adapter band.

3. An adapter according to claim 2, comprised of a polypropylene and polyethylene copolymer.

4. An adapter according to claim 1, the bottom portion further comprising a central yoke extending from the neck, a bottom portion of the yoke extending into the lower band, the yoke being generally horizontally oriented, the yoke having a greater diameter than the diameter of the neck.

5. An adapter according to claim 4, wherein the neck is removably insertable in an opening of the air filter housing, and the lower band is removably insertable into an open end of a carburetor duct.

6. An adapter according to claim 5, wherein the neck and lower band are substantially vertically oriented, as is the air filter housing, while the yoke is substantially horizontally oriented.

7. An adapter according to claim 6, further comprising a beveled upper lip or lower lip.

8. An adapter according to claim 7, wherein the neck and lower band are generally straight and cylindrical, with a substantially consistent diameter, the yoke being downwardly curved.

9. An adapter according to claim 3, further comprising a substantially malleable, circular upper annulus encircling the outside of the adapter neck, or a substantially malleable, circular lower annulus encircling the outside of the lower band.

10. An adapter according to claim 3, further comprising a fine, removable net across an inlet opening of the adapter.

11. An adapter according to claim 10, wherein the net is imbued with a gas-absorbent chemical for absorbing harmful gases passing through a hollow center of the adapter.

12. An adapter according to claim 10, wherein charcoal particles of a diameter less than about 100 microns are suspended in the net.

13. An adapter according to claim 10, further comprising a rubber-type ring that fits closely around an edge of the net and encircles the upper ring end of the adapter.

14. An adapter according to claim 3, further comprising a wind ring attachable to the lower ring end of the adapter, the wind ring comprising a plurality of fins extending into a hollow center of the adapter.

15. An adapter according to claim 14, wherein the wind ring has the same outside diameter as the lower ring end, the wind ring being made of a metallic material and comprising between about four and six of the plurality of fins.

16. An air filter adapter for removably attaching an air filter housing to a carburetor duct, the adapter comprising:
(a) a substantially cylindrical top portion comprising generally circular upper and lower ring openings at either end, the upper and lower ring openings having substantially the same diameter;
(b) a bottom portion comprising a substantially planar, ring-shaped yoke extending out in a generally horizontal direction from the lower ring opening end of the generally vertical neck, and a band extending in an upward direction from the ring-shaped yoke;
wherein the upper ring opening end is removably insertable in an opening of the air filter housing, the band being removably insertable in an open end of the carburetor duct.

17. An adapter according to claim 16, further comprising a first ring clamp fastened around the outside of the end of the air filter housing over an end of the adapter, and a second ring clamp fastened around the outside of the end of the carburetor duct over an opposite end of the adapter.

18. A method for increasing efficiency of a motorcycle engine, comprising the steps of:
a) removing a stock air box, stock air filter, and stock hose between the stock air filter and the stock air box of the motorcycle;
b) inserting a portion of at least one adapter into a carburetor duct of the motorcycle, the at least one adapter comprising: (1) a substantially cylindrical top portion comprising a neck ending in a generally circular upper ring opening; and (2) a bottom portion integral with the top portion, the bottom portion comprising a substantially cylindrical band extending from the neck, the band ending in a generally circular lower ring opening, the upper ring opening having a substantially smaller diameter than the diameter of the lower ring opening;
c) inserting an end of at least one removable air filter housing into the top portion of the at least one adapter; and
d) removably attaching the at least one adapter in place;
whereby the at least one air filter housing is removably connected to a carburetor of the motorcycle by at least one of the carburetor ducts through the at least one adapter.

19. A method according to claim 18, wherein two of the at least one air filter housings are each removably connected to the top portion of the at least one adapter, the bottom portion of the at least one adapter being removably connected to an upper end of the motorcycle carburetor duct, the motorcycle having two of the at least one adapters, and two of the carburetor ducts.
